(19) United States
(12) Patent Application Publication
(10) Pub. No.: US 2017/0231357 A1
(43) Pub. Date: Aug. 17, 2017

(54) Electrostatic Inhibiting Application Device

(71) Applicant: Jason F. Brandenburg, Portage, MI (US)

(72) Inventor: Jason F. Brandenburg, Portage, MI (US)

(73) Assignee: Jason Frederick Brandenburg, Portage, MI (US)

(21) Appl. No.: 15/046,266

(22) Filed: Feb. 17, 2016

(51) Int. Cl. A45D 19/16; A46B 15/00; H05F 1/02; A47G 25/00

(52) U.S. Cl. CPC A45D 19/16; A47G 25/00; A46B 15/0055; H05F 1/02; A46B 2200/104

(57) ABSTRACT

A device for the treatment of the surfaces of people, animals, or objects for the purpose of inhibiting the accumulation and discharge of electrostatic energy. The invention is comprised of a handle (1) or base or some other structural support accompanied by a replaceable a dryer sheet (4). Dryer sheet (4) will be constrained in such a way that it can be easily manipulated into physical contact with the user of the device, an animal, or some other object. Using the device causes the electrostatic inhibiting properties of a dryer sheet (4) to be transferred directly to the target object, person, or animal.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The random discharge of accumulated electrostatic energy is an unpleasant fact of life and can be a common occurrence in dry environments. Unless somehow prohibited, static electricity can discharge through the nearest available ground, even if that ground happens to be a human. Sometimes referred to as a “shock” or a “poke”, the sudden discharge of electrostatic energy is a nuisance in everyday life and is unpleasant to experience when it happens.

As used herein, the phenomenon of sudden electrostatic discharge will be referred to as “ESD”. Also, the term “static fighting” will describe the ability to treat a surface in such a way to inhibit the accumulation of electrostatic energy that could later result in ESD.

Some materials that are classified as non-conductors of electricity have the inherent property of generating a static charge of electrical energy when rubbed against certain other materials. Such electrostatic generating materials are numerous. They include fabrics, wool, fur, hair, metals, coatings, synthetics, and plastics.

Articles made from these materials have the capacity for electrostatic charge accumulation. For example, a known phenomenon related to the act of grooming hair or fur is the build-up and discharge of electrostatic energy. Electric charge can accumulate as a result of friction between hair and bristles during the brushing process. The discharge of this energy is unpleasant and can cause hair to be unmanageable, split, and be more prone to attracting dust.

It is common for electrostatic energy to accumulate on hair and clothing. This phenomenon can occur in other objects as well. It can build up on the surfaces of pets, furniture, appliances, computers, screens, carpets, tables, keyboards, speakers, handrails, shop machinery, automobiles, and more. ESD can cause failures in electronic devices, and has been known to trigger fires at fuel station pumps. I have found no practical uses for the electrostatic energy that builds up and discharges through some objects, materials, and people. ESD must simply be tolerated in the daily life of all.

### PRIOR ART

Many ways exist to deal with ESD. The following is a tabulation and explanation of prior art that presently appears relevant:

### Prior Art Describing Personal Grooming Devices

US 2004/0016066A1, Jan. 29, 2004—Frazier et al. teaches a static removing hair brush with a grounding clip.

US 2003/0209252A1, Nov. 13, 2003—Choy claims an antistatic grooming device for hair by utilizing static dissipative materials but does not provide any embodiments or offer any specific constructions for how to accomplish this.

US 2002/0062836A1, May 30, 2002—Saida et al. teaches a hairbrush form that is constructed from electrically isolative material with an ion generator device integral to the form.

U.S. Pat. No. 5,967,150, Oct. 19, 1999—Wright et al. teaches a motorized combing device where the comb part is primarily made up of carbon-rich de-ionizing material.

U.S. Pat. No. 5,150,491, Sep. 29, 1992—Ikemoto teaches a specific construction for a hair brush that inhibits the build-up of electrostatic charge in hair as the brush is being used for grooming.

U.S. Pat. No. 4,797,966, Jan. 17, 1989—Fong teaches a highly specialized brush construction with a ground source built into the device.

U.S. Pat. No. 4,610,925, Sep. 9, 1986—Bond teaches a specially constructed bristle for a hair brush with antistatic properties.

U.S. Pat. No. 4,500,939, Feb. 19, 1985—Gueret teaches a flexible base hairbrush that contains anti-static properties in at least some of the bristles.

U.S. Pat. No. 4,290,438, Sep. 22, 1981—Price teaches a combing device that is plugged into a conventional electrical outlet with a grounding terminal.

U.S. Pat. No. 3,084,700, Apr. 9, 1963—R. M. Fischer et al. teaches a combing device with a grounding clip electrically connected to the teeth of the comb.

U.S. Pat. No. 2,665,443, Jan. 12, 1954—Simon teaches a specialized brush bristle that is made from etymols.

The preceding inventions all claim to alleviate the effects of ESD in human hair. These solutions rely on special construction methods, exotic materials, or electronic assemblies to reduce the effects of ESD while grooming hair. Some of these inventions even require a power source in order to work. For these reasons, the prior art presented here is likely to cost more than a brush made from standard materials and production methods. Therefore, a simple, inexpensive, renewable method that does not require an external power source for the treatment of hair to diminish the potential for ESD is desirable.

### Prior Art Describing Chemical Compounds

US 2010/0064979A1, Mar. 18, 2010—Leonard teaches a device with the primary purpose of calming animals.

U.S. Pat. No. 7,337,784 B2, Mar. 4, 2008—Hurwitz teaches a hairbrush with a chamber for holding a liquid chemical compound.

U.S. Pat. No. 5,495,633, Mar. 5, 1996—Speer teaches a non-pressurized device containing for the treatment of “static cling” in clothing.

U.S. Pat. No. 4,676,915, Jun. 30, 1987—Steltenkamp et al. teaches a chemical compound that can be added to laundry detergent and hair shampoo that will diminish the tendency for the accumulation of electrostatic energy build up.

U.S. Pat. No. 4,129,505, Dec. 12, 1978—Dasher et al. teaches an anti-static spray for the treatment of electrostatic charge buildup in clothing.

Numerous chemically based products are effective at helping to prevent ESD in hair and clothing. The preceding chemical based inventions may require multiple steps to apply and can even specify certain environmental conditions to be effective. Such chemicals can leave behind residue and cause hair and fabrics to become greasy, brittle, faded, or dry. Liquids can be messy and inconvenient to carry around. Therefore, a low cost simple method that does not require chemically complex substances or devices for delivering chemicals to deal with ESD is desirable.

### Prior Art Describing Complex Devices

U.S. Pat. No. 5,426,870, Jun. 27, 1995—Purnell et al. teaches a specially designed shoe sole construction that protects the wearer of the shoe from unwanted ESD.

U.S. Pat. No. 4,680,668, Jul. 14, 1987—Belkin teaches an apparatus that is worn by the user that is continuously grounded via wire connected to a ground source.

U.S. Pat. No. 3,745,412, Jul. 10, 1973—Ruff teaches a small device worn like a ring that can dissipate stored electrostatic energy potential by directing it through a resistor.

The preceding inventions claim to deal with ESD using electronic hardware or a highly specialized construction. These devices do not inhibit the accumulation of electrostatic energy, rather they are designed to allow electrostatic energy to discharge somewhere away from the user. Solutions such as these may be effective for certain situations, but the cost to employ them is considerable. Therefore, a low cost simple method that does not require the use of a complex device is desirable.

None of the above solutions, taken alone or in combination, is seen to describe the present invention as claimed. Thus, a simple, reusable device that allows a user to conveniently wield dryer sheets to bring them into physical contact with a person or object for the intent of inhibiting unwanted ESD is desirable.

### OBJECT OF THE INVENTION

It is the object of the present invention to provide a convenient method to treat the surface of a person or object to reduce the likelihood of ESD. Another object of the present invention is to provide a low cost and widely available solution to the problem of unwanted ESD. From the explanation herein, it will be understood that I have provided a highly effective portable device specifically designed to decrease the potential for ESD to occur between humans and other humans, objects, clothing, hair, or fur.

It should also be understood that the use of a dryer sheet is key for all embodiments within this application. Dryer sheets contain one or more additives with electrostatic neutralizing properties that are easily transferred to persons, animals, or objects that are made to experience physical contact with one. As used herein, dryer sheet is understood to be a widely available consumer product commonly presented as “dryer sheet” on packaging and merchandising material.

### SUMMARY OF THE INVENTION

A device that allows the user to create physical contact between the surface of a dryer sheet and most objects. The intent of the physical contact is to transfer the static fighting properties contained within a dryer sheet to people, animals, and most objects.

### Advantages of the Invention

I have found that the application of dryer sheets is a reliable and effective method for inhibiting the accumulation of electrostatic energy in hair, fur, and most other objects. If used to treat wet hair, the static fighting effects can remain for hours after the initial use. Brief physical contact between the surface of a dryer sheet and people, animals, or objects inhibits the ability for these things to accumulate electrostatic energy that can later release in the form of ESD. Repeated and regular use of dryer sheets in this manner maximizes the desirable static fighting effects.

The present invention is easy to use and is a simple construction. It does not contain electronics, nor does it require a complex process to be manufactured. The technology, processes, and materials required to create this device already exist. This device can be made available to a large number of people at a relatively low cost. Additionally, dryer sheets are inexpensive, replaceable, and easy to obtain.

### DRAWING DESCRIPTIONS

FIG. 1 is an exploded perspective view of one possible embodiment of the present invention that can be described as a grasping handle with a removable affixed dryer sheet.

FIG. 2 is a partially assembled perspective view of the apparatus components illustrated in FIG. 1.

FIG. 3 is an assembled perspective view of the apparatus components illustrated in FIG. 1.

FIG. 4 is a cut-away view of the assembled apparatus illustrated in FIG. 3.

FIG. 5 is an exploded perspective view of another possible embodiment of the invention with a grasping handle, bristle features, and a removable affixed dryer sheet.

FIG. 6 is an assembled perspective view of the apparatus components illustrated in FIG. 5 depicting the lid feature in an ‘open’ state.

FIG. 7 is an assembled perspective view of the apparatus components illustrated in FIG. 5 depicting the lid feature in a ‘closed’ state.

FIG. 8 is a bottom side view of the assembled apparatus components illustrated in FIG. 5 depicting the lid feature in a ‘closed’ state.

FIG. 9 is a cut-away view of the assembled apparatus illustrated in FIG. 8 depicting how the assembled components are constrained.

### DRAWINGS—REFERENCE NUMERALS

1 handle
2 sheet retainer
3 pin
4 dryer sheet
5 handled-brush body
6 dryer sheet assembly compartment
7 void area
8 sheet holder
9 bristles
10 hinge
11 lid
12 lid magnet
13 handle magnet
14 lid compartment

### Detailed Description of the First Embodiment

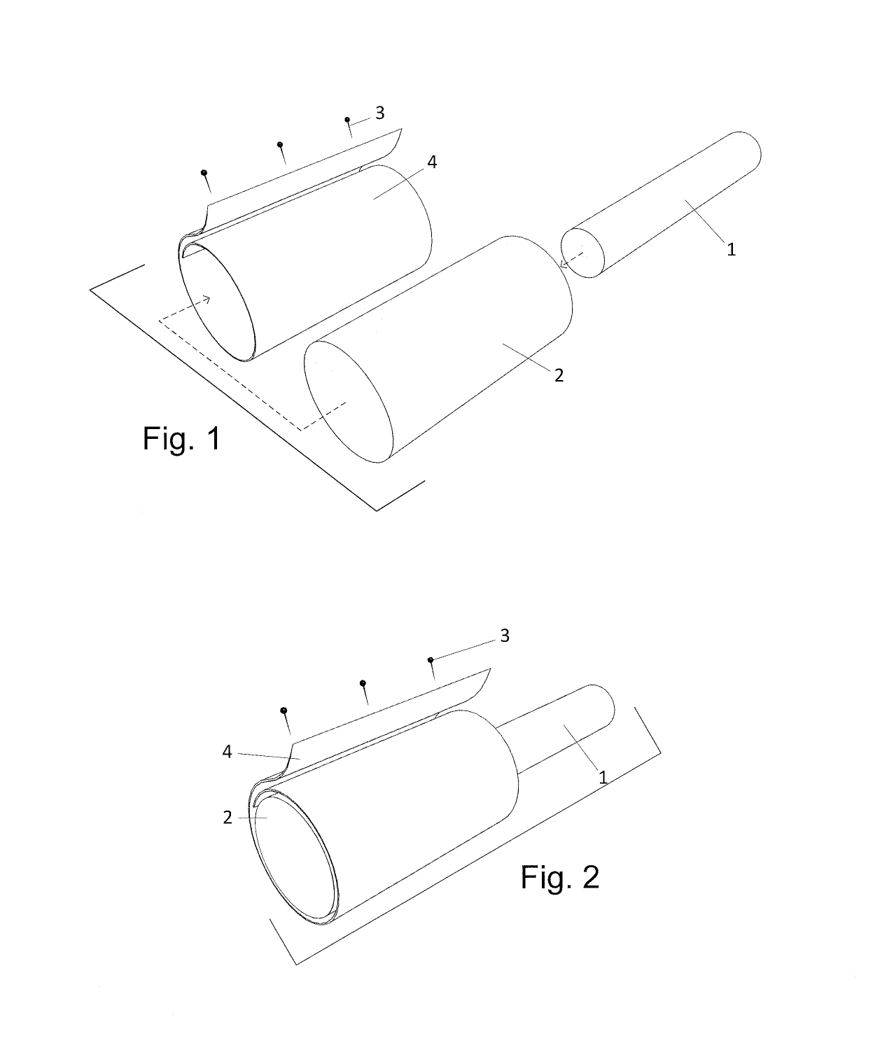

The first embodiment of the invention is depicted in FIGS. 1, 2, 3, and 4. Handle 1 is a ridged member that is connected to sheet retainer 2. Handle 1 is a grasping feature that is shaped and sized to be convenient for holding. Sheet retainer 2 is a cylindrical shape constructed of material suitable for retaining inserted retention pins 3. Retention pins 3 are commonly the form of small, slender, pointed, ridged objects with rounded geometry on one end. Dryer sheet 4 is the form of a widely available consumer product commonly presented as “dryer sheet” on packaging and merchandising material.

### Operation of the First Embodiment

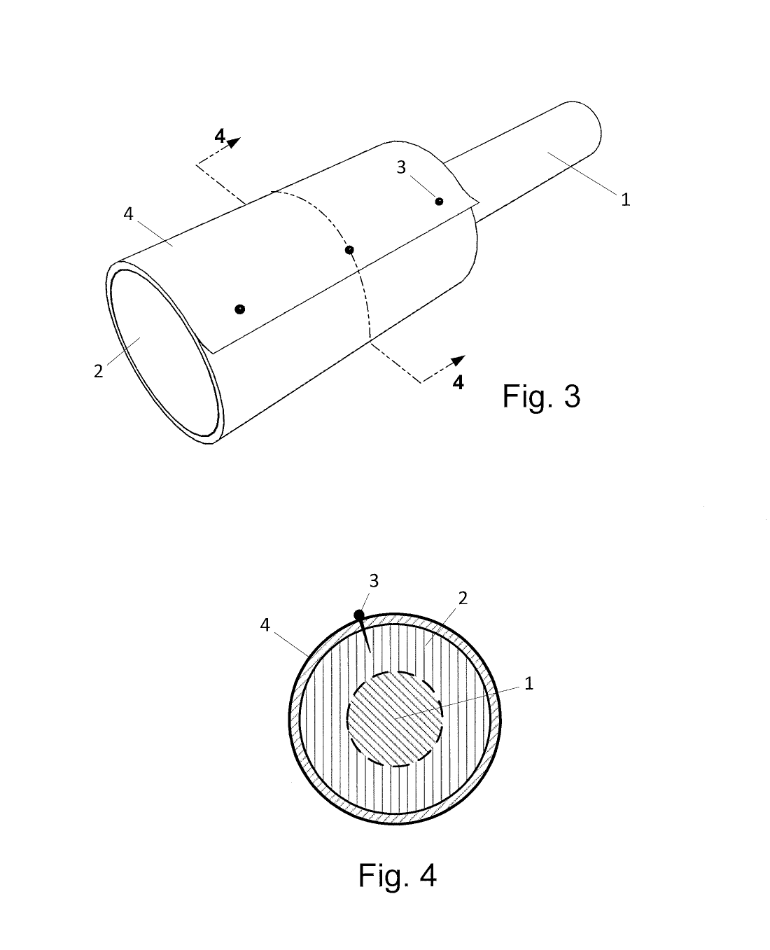

FIG. 3 illustrates an embodiment that allows a user to easily bring dryer sheet 4 into physical contact with a surface. Key features of this assembly include handle 1 and a removable affixed dryer sheet 4. In operation, dryer sheet 4 is first rolled onto sheet retainer 2. Once in place, one or more pins 3 are inserted in a way that dryer sheet 4 becomes constrained to sheet retainer 2. As sheet retainer 2 is solidly attached to the handle 1, the user can now grasp handle 1 and wield the device to bring dryer sheet 4 into physical contact with an object.

FIG. 4 is a view into a transverse cross section of the embodiment of FIG. 3 illustrating how dryer sheet 4 is installed and retained to sheet retainer 2. Dryer sheet 4 is wrapped around sheet retainer 2. Pins 3 are inserted through dryer sheet 4 and extend into the interior of sheet retainer 2. The static frictional force between pins 3 and the material of sheet retainer 2 prevent pins 3 from backing out of the assembly.

### Detailed Description of the Second Embodiment

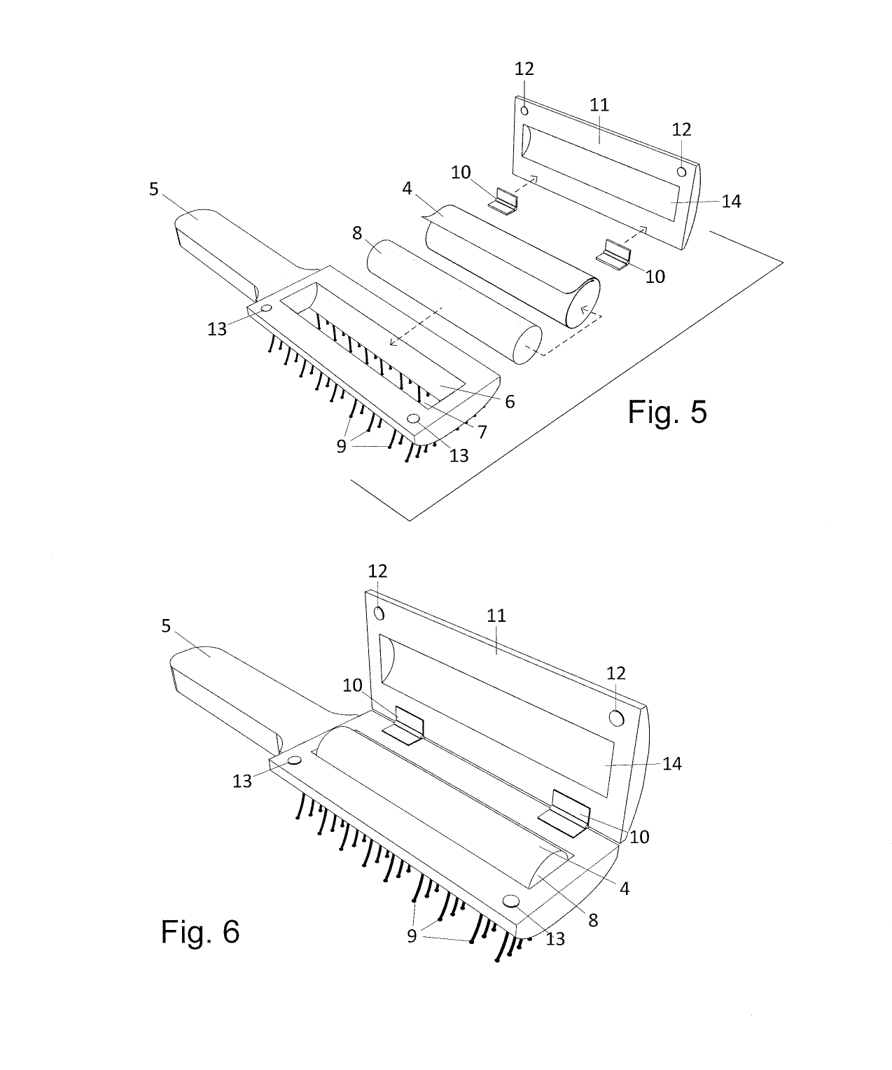

A second embodiment of the invention is depicted in FIGS. 5, 6, 7, 8, and 9. Handled-brush body 5 is a ridged member used for grasping with the key features of a dryer sheet assembly compartment 6 and bristles 9. Dryer sheet 4 is the form of a widely available consumer product commonly presented as “dryer sheet” on packaging and merchandising material. Dryer sheet assembly compartment 6 contains a void area 7 that continues all the way through to the opposite side of handle 5. Dryer sheet assembly compartment 6 is shaped to accommodate an assembly consisting of dryer sheet 4 and sheet holder 8.

Sheet holder 8 is shaped and sized to accommodate being wrapped completely by dryer sheet 4 and while securely fitting into the geometry of dryer sheet assembly compartment 6. Hinge 10 is a typical jointed device simultaneously attached to lid 11 and handled-brush body 5. Lid 11 contains a pocketed feature lid compartment 14. Bristles 9 are typical of the bristle features that would be found on a widely available common hair brush. Bristles 9 are slender semi-rigid members integral to and protruding out from the underside of handled-brush body 5.

Hinge 10 is simultaneously attached to lid 11 and handled-brush body 5 on the surface opposite of where bristles 9 protrude from. The underside of lid 11 contains a feature lid compartment 14 that partially encapsulate the assembled components of dryer sheet 4 and sheet holder 8. Lid magnet 12 is fixed to lid 11. Handle magnet 13 is fixed to handled-brush body 5. The polarity of the outward facing surface of lid magnet 12 is opposite the polarity of the outward facing surface of handle magnet 13. When lid 11 is in a ‘closed’ state, lid magnet 12 and handle magnet 13 are positioned in a way to become magnetically attracted to each other.

### Operation of the Second Embodiment

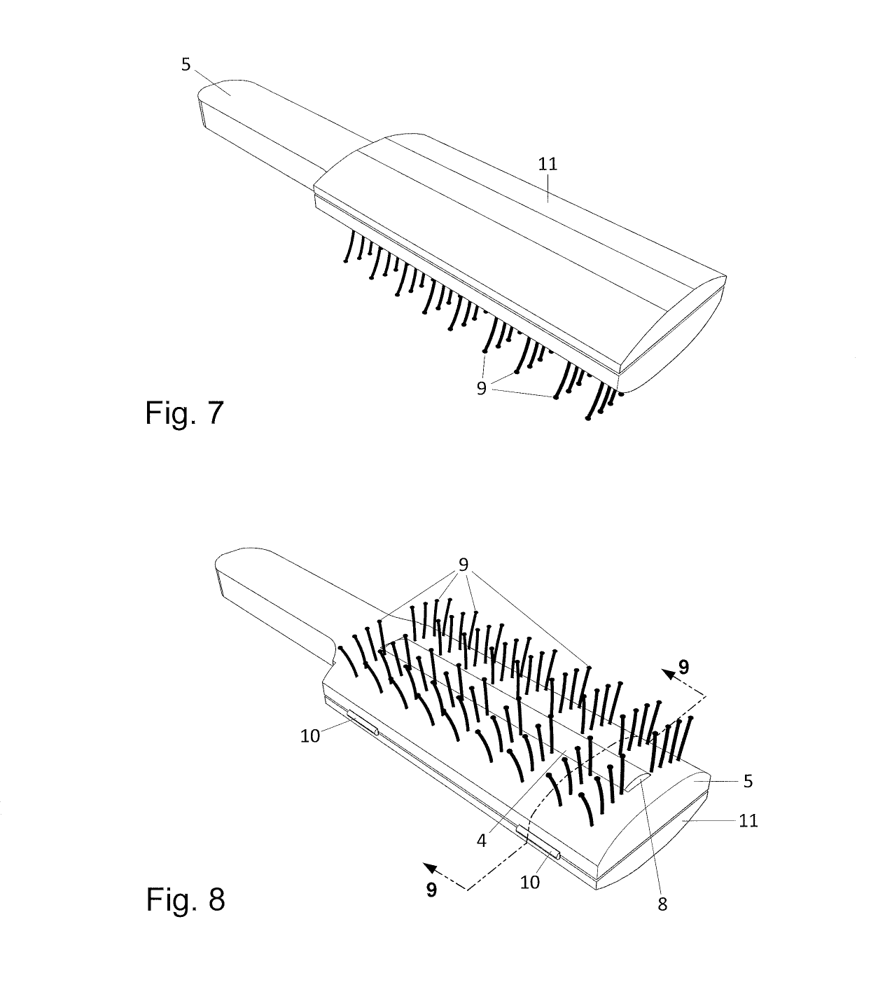

Open the assembly by pivoting lid 11 to an ‘open’ state. This is accomplished by pivoting hinges 10 from the ‘closed’ state depicted in FIG. 7 to the ‘open’ state depicted in FIG. 6. Dryer sheet 4 is rolled up to completely wrap around the exterior of sheet holder 8. The assembly of dryer sheet 4 and sheet holder 8 is placed into dryer sheet assembly compartment 6.

With the assembled dryer sheet 4 and sheet holder 8 installed to handled-brush body 5, close lid 11 by pivoting hinges 10 from the ‘open’ state depicted in FIG. 6 to the ‘closed’ state depicted in FIG. 7. When the closing operation is complete, lid magnet 12 and handle magnet 13 will be in close proximity. The opposite polarity of lid magnet 12 and handle magnet 13 will cause these components to be magnetically attracted to each other. The resulting magnetic forces will retain the assembly of dryer sheet 4 and sheet holder 8 inside the device.

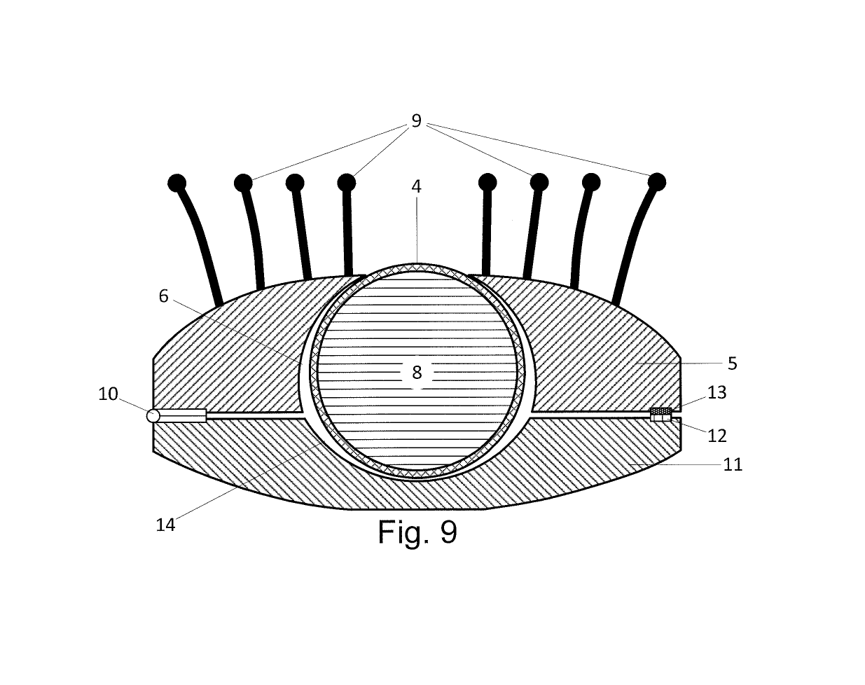

Illustrated in FIG. 9, the assembly of dryer sheet 4 and sheet holder 8 is constrained between lid compartment 14 and compartment 6. Dryer sheet 4 is fully retained within the assembly and prohibited from movement during use. A portion of the surface of dryer sheet 4 passes through void area 7 and is exposed to any surface the user chooses to perform the act of brushing on.

The user grasps handled-brush body 5 to wield the device and perform the common act of brushing on any suitable surface. This motion will bring dryer sheet 4 into physical contact with hair, fur, or any material that can be brushed.

### Alternative Embodiments

The forgoing embodiments are meant to be considered illustrative rather than restrictive for the invention. A countless number of other embodiments are possible. Not all possible constructions are listed in this application.

### RAMIFICATIONS AND SCOPE

While the above descriptions contain much specificity, this should not be construed as limitation on the scope, but rather as an exemplification of several embodiments thereof. Other variations of this invention are possible. For example, devices designed specifically to facilitate physical contact between a dryer sheet and livestock, fabrics, books, pets, clothing, floors, tables, seats, furniture, machinery, electronic equipment, appliances, or any other objects, meet these criteria and can be considered variations on the invention being claimed. The device itself may exhibit an alternative design, form, shape, or size provided a dryer sheet is utilized in the operation of the device.

### CONCLUSION

To summarize, the ESD inhibiting device described allows a user to conveniently wield a dryer sheet such that it can be made to come into physical contact with almost any surface for the purpose of reducing the chance for ESD to occur.

What is claimed is:

1. A device that facilitates the transfer of the anti-static properties contained in a dryer sheet from said dryer sheet to people, animals, or most objects that are encountered by people.

2. Said device in claim 1 whose purpose is to retain a typical dryer sheet so that it can be manipulated to come into close proximity or direct contact with people, animals, or most objects that are encountered by people.

3. Said device in claim 1 that is convenient, and not cost prohibitive to own and operate.

4. Said device in claim 1 that will make possible the use of a dryer sheet as a conditioning agent for hair.
